(19) United States
(12) Patent Application Publication
(10) Pub. No.: US 2012/0186603 A1
(43) Pub. Date: Jul. 26, 2012

(54) ORTHODONTIA FLOSSER

(76) Inventor: ANGELIA D. HALL, Powder Springs, GA (US)

(21) Appl. No.: 13/351,125

(22) Filed: Jan. 16, 2012

Related U.S. Application Data
(60) Provisional application No. 61/434,669, filed on Jan. 20, 2011.

(51) Int. Cl. A61C 15/04

(52) U.S. Cl. 132/323

(57) ABSTRACT

The orthodontia flosser includes a floss head integrally attached to an elongate handle. The handle includes a finger depression at the attachment juncture to facilitate ergonomic gripping of the orthodontia flosser for use thereof. The floss head includes a pair of arms extending perpendicular to the handle. A recess in each arm supports floss therebetween and maintains the floss in a taut condition. The arms may be dimensioned to reach under the wires of bracers.

### CROSS-REFERENCE TO RELATED APPLICATION

This application claims the benefit of U.S. Provisional Patent Application Ser. No. 61/434,669, filed Jan. 20, 2011.

### BACKGROUND OF THE INVENTION

1. Field of the Invention

The present invention relates to oral hygiene devices, and more particularly to an orthodontic flosser for flossing teeth and/or teeth with braces with relative ease.

2. Description of the Related Art

Oral hygiene is a vital component in maintaining strong and healthy teeth. Lack thereof can lead to gingivitis, periodontal disease, demineralization and fracturing of the teeth enamel.

The above effects are more susceptible in orthodontic patients who have dental appliances such as braces. The metal wires and brackets of the orthodontic appliance traps food debris, plaque and biofilm, which thereby build up on teeth and under the gum line, causing tooth decay and gingivitis. Flossing is one method that helps reduce such an occurrence, but majority of the available flossing devices are not user-friendly for those with orthodontic appliances. It would be a benefit in the art of orthodontic devices to provide a flossing device that may be easily used by both orthodontic patients and others.

Thus, an orthodontia flosser solving the aforementioned problems is desired.

### SUMMARY OF THE INVENTION

The orthodontia flosser includes a floss head integrally attached to an elongate handle. The handle includes a finger depression at the attachment juncture to facilitate ergonomic gripping of the orthodontia flosser for use thereof. The floss head includes a pair of arms extending perpendicular to the handle. A recess in each arm supports floss therebetween and maintains the floss in a taut condition. The arms are of a size to reach under the wires of braces.

These and other features of the present invention will become readily apparent upon further review of the following specification and drawings.

### BRIEF DESCRIPTION OF THE DRAWINGS

FIG. 1 is an environmental, perspective view of an orthodontia flosser according to the present invention.

FIG. 2 is a perspective view of the orthodontia flosser according to the present invention.

FIG. 3 is a side view of the orthodontia flosser according to the present invention.

FIG. 4 is a partial side view of the orthodontia flosser of FIG. 3, the head being broken away and partially in section to show details thereof.

FIG. 5 is a perspective view of an alternative embodiment of an orthodontia flosser according to the present invention.

FIG. 6 is a rear view of the orthodontia flosser shown in FIG. 5.

FIG. 7 is a top view of the orthodontia flosser shown in FIG. 5.

Similar reference characters denote corresponding features consistently throughout the attached drawings.

### DETAILED DESCRIPTION OF THE PREFERRED EMBODIMENTS

The present invention relates to an orthodontia flosser, generally referred to in the drawings by reference number 10, for flossing teeth with relative ease. Initially, it is noted that the orthodontia flosser 10 has been configured to assist orthodontia patients to floss in a manner that overcomes the encumbrance of dental appliances such as braces. However, anyone can use the orthodontia flosser 10 with similar ease.

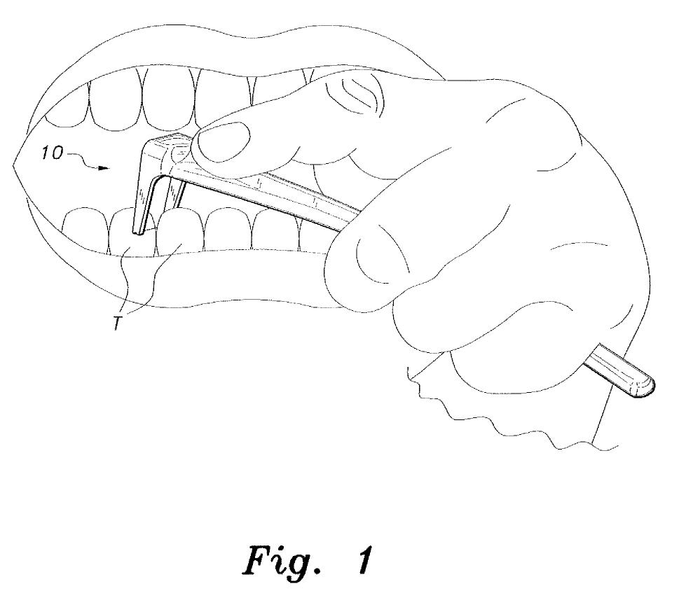

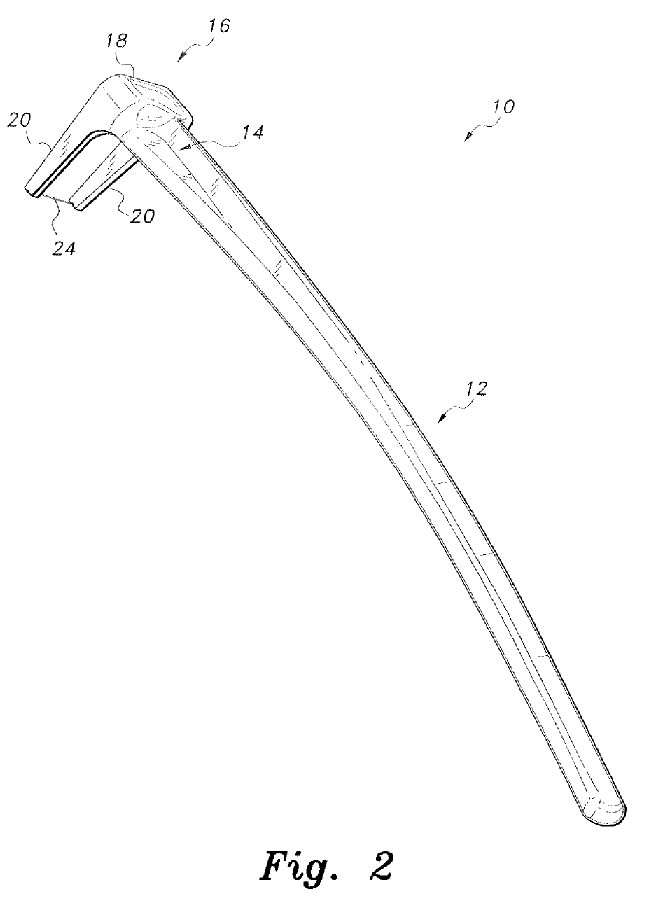

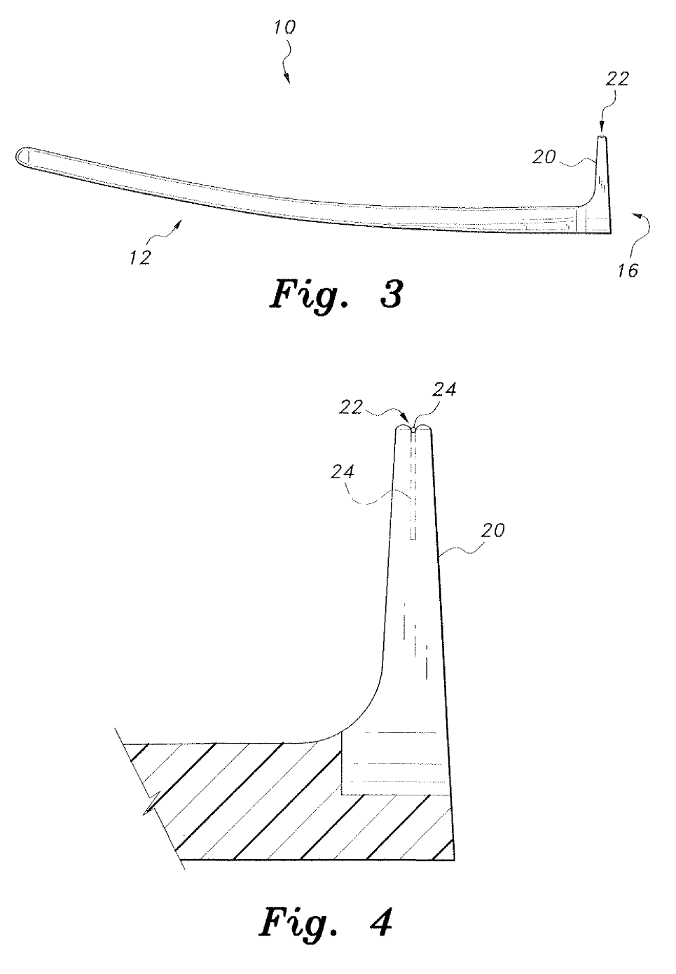

As shown in FIGS. 1-4, the orthodontia flosser 10 includes an elongated handle 12 attached to a floss head 16. The handle 12 is preferably integral with the floss head 16. However, the orthodontia flosser 10 may be configured so that the floss head 16 is detachable. In this manner, the floss head 16 may be easily disposed and replaced with a new one and vice versa with respect to the handle 12.

The handle 12 is long and slightly curved so as to be comfortably grasped by the user. The handle 12 is substantially rectangular in cross section that gradually flattens out towards the bottom half of the handle 12. The flattened area provides an ergonomic area where the palm of the user can rest while gripping the handle 12. The top of the handle 12 also includes an elongate finger depression 14 at a corner thereof, which extends from the juncture between the head 16 and the handle 12 a short distance clown towards the distal end. The finger depression 14 is ideally located to permit the user to place a finger or thumb thereon. This ergonomic feature permits the user to maneuver the floss head 16 into operative position and floss between the teeth T with relative ease.

The floss head 16 may be a substantially U-shaped body having a base 18 and a pair of arms 20 extending therefrom. The floss head 16 is attached to the handle 12 at the base 18, and the arms 20 extend perpendicularly therefrom. Each arm 20 includes a recess, notch, or depression 22 at its free or distal end upon which floss 24 may be internally threaded and supported thereon in a similar manner to a bow. In fact, the floss 24 may be manufactured so that a substantial portion of the ends of the floss 24 is embedded inside the respective arms 20. In this manner, the floss 24 is stretched between the arms 20 to keep the same taut for use.

The following describes how to use the orthodontia flosser 10. The handle 12 is placed comfortably in the hand of the user. The floss head 16 is guided to enter between the teeth T from the lingual or tongue side. One of the arms 20 should be placed over and on the bracket side or the outer side of the tooth at the interproximal junction. The floss head 16 is pushed downward and upward to gently slide the floss 24 between the teeth T and under the gum. Backward and forward and an upward and downward motion is used against the edge of the teeth T to remove food debris and plaque from the teeth T and gums. When finished, the used floss or contaminated orthodontia flosser 10 can be properly disposed of. If desired, the orthodontia flosser 10 can be reused by disposing of contaminated floss, then washing the used flosser with water and mild soap and allowed to dry prior to reuse. The ease of handling and use permitted by the orientation of the head 16 and the finger depression 14 helps to reduce and prevent dental caries, enamel fractures and gingivitis.

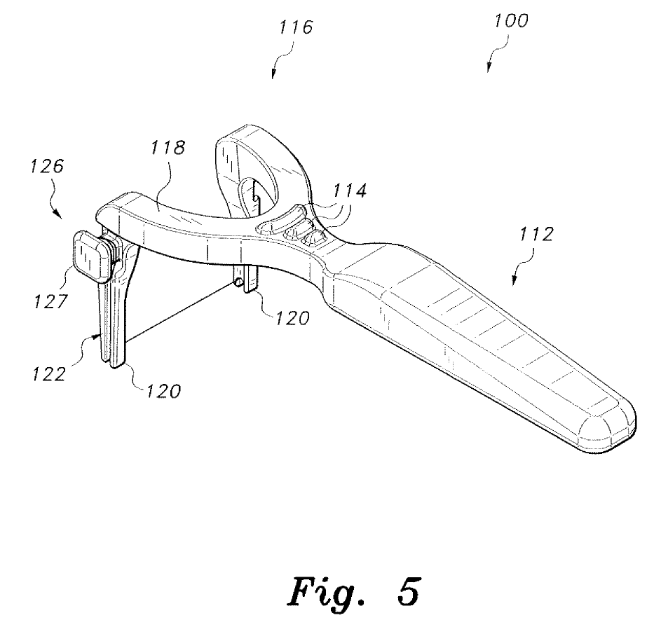

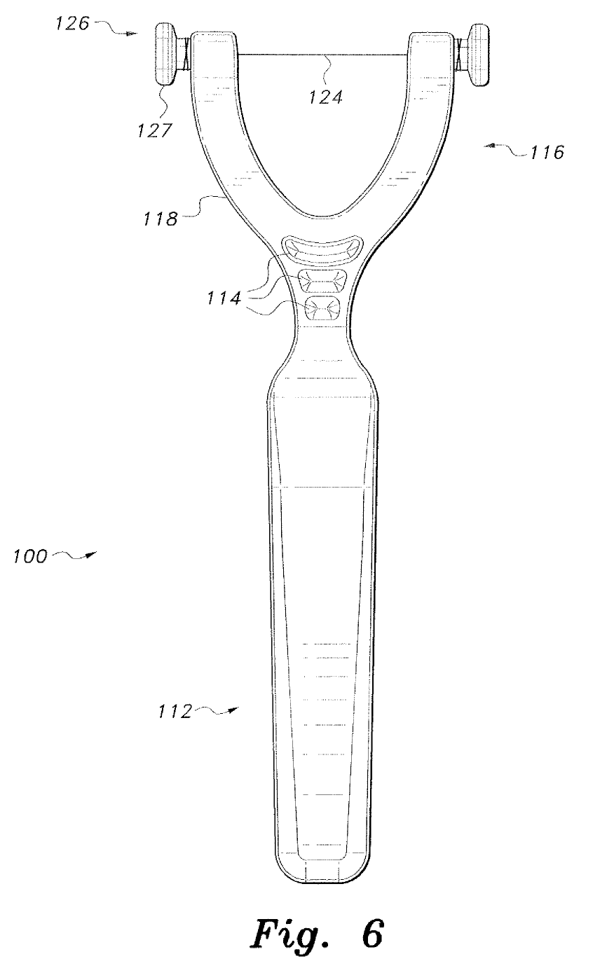

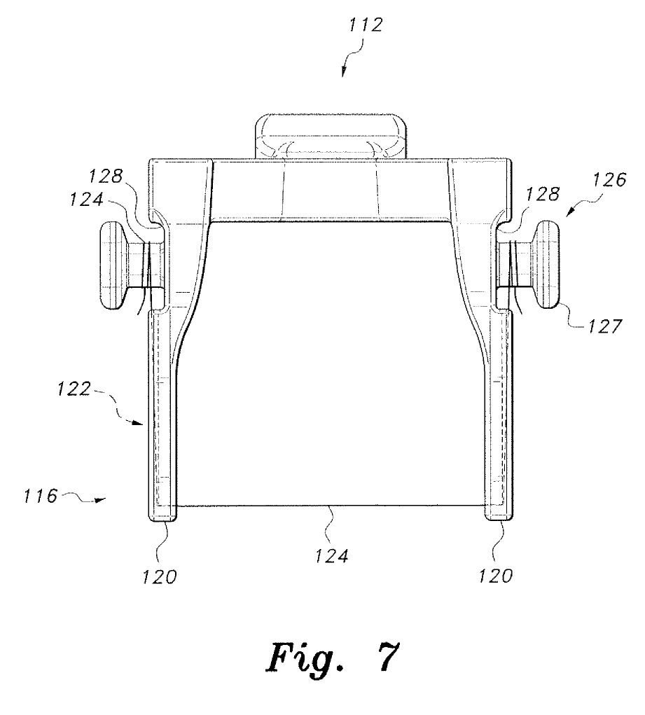

An alternative embodiment of the orthodontia flosser 100 is shown in FIGS. 5-7. In this embodiment, the orthodontia flosser 100 includes additional ergonomic features for ease of preparation and use. Moreover, the orthodontia flosser 100 is configured to be reusable, if desired.

As shown, the orthodontia flosser 100 includes an elongated handle 112 attached to a floss head 116. The handle 112 is preferably integral with the floss head 116. However, the orthodontia flosser 100 may be configured so that the floss head 16 is detachable. In this manner, the floss head 116 may be easily disposed and replaced with a new one and vice versa with respect to the handle 112.

The handle 112 is long and slightly curved with an enlarged area near the floss head 116 so that the handle 112 may be comfortably grasped by the user. The handle 112 is substantially rectangular in cross section and gradually flattens out towards the bottom half of the handle 112. The flattened area provides an ergonomic area where the palm of the user can rest while gripping the handle 112. The top of the handle 112 also includes an elongate depression where a plurality of finger ridges or protrusions 114 are formed thereon. These finger ridges 114 form a gripping means that enhance grip for the user's finger or thumb during the course of using the orthodontia flosser 100. The depression is formed at the juncture between the head 116 and the handle 112 and extends a short distance down towards the distal end. The finger ridges 114 are ideally located to permit the user to place a finger or thumb thereon.

The floss head 116 may be a substantially U-shaped body having a yoke or bifurcated base 118 and a pair of arms 120 extending therefrom. The floss head 116 extends from the handle 112 at the base 118, and the arms 120 extend perpendicularly therefrom. Each arm 120 includes an L-shaped groove or channel 122 upon which floss 124 may be threaded and supported thereon in a similar manner to a string on a bow. The portion of the groove 122 extending to the tip end of each arm 120 forms prongs, ensuring that the floss 124 threaded thereon will not slip.

To facilitate winding of the floss 124, each arm 120 includes a recess or depression 128, and a binding post 126 extends outwardly from the recess 128. One end of the floss 124 is wound on one of the binding posts 126 and threaded through the groove 122 on the respective arm 120. The rest of the floss 124 is threaded through the groove 122 on the other arm 120, and the other end of the floss 124 is secured to the other binding post 126. The floss 124 is stretched and held taut between the arms 120 in this manner, and the tautness thereof is determined by how tightly the user winds the ends of the floss 124 around the binding posts 126 and the grooves 122. The orthodontia flosser 100 is now ready for use in a manner similar to the orthodontia flosser 10 described above.

As shown in FIGS. 5 and 7, the recesses 128 each provide space for the user's fingers to ease securing of each end of the floss 124. In addition, each binding post 126 includes an enlarged head or cap 127 at the distal end to prevent the floss end from sliding out of secure engagement with the binding post 126.

It is to be understood that the orthodontia flossers 10, 100 encompass a variety of alternatives. For example, the orthodontia flossers 10, 100 are preferably made from lightweight plastic. However, other materials such as lightweight, nonporous, food grade composites, steel, wood, or a combination thereof may also be used. Moreover, the orthodontia flosser 10, 100 may include a variety of colors and indicia.

It is to be understood that the present invention is not limited to the embodiments described above, but encompasses any and all embodiments within the scope of the following claims.

I claim:

1. An orthodontia flosser, comprising:
an elongated handle having a flattened lower end and an upper end, the upper end having a finger depression extending partially down along the length of the handle for a user to place a finger or thumb thereon and provide a grip for easy maneuverability; and
a floss head attached to the upper end of the handle, the floss head having a U-shaped body including a base and a pair of arms extending perpendicularly from the handle, each of the arms having a distal free end having a depression therein adapted for supporting floss between the ends of the arms in a taut manner.

2. The orthodontia flosser of claim 1, further comprising a length of floss having opposing ends and a central portion between the opposing ends, the ends of the length of floss being embedded in the arms of said floss head, the central portion of the length of floss tautly spanning between the ends of the arms.

3. The orthodontia flosser of claim 1, wherein the finger depression begins at a juncture between said floss head and said handle to extend partially along the length of said handle.

4. The orthodontia flosser of claim 1, wherein the flattened lower end of said handle includes an area for placing the user's palm during use.

5. The orthodontia flosser of claim 1, wherein said handle is arcuately curved.

6. An orthodontia flosser, comprising:
an elongated handle, the handle having an upper end, a lower end, and means for gripping the handle formed on the upper end, the means for gripping permitting a user to place a finger or thumb thereon to provide enhanced grip for easy maneuverability; and
a floss head attached to the upper end of the handle, the floss head having a substantially U-shaped body including a bifurcated base and a pair of arms extending perpendicularly from the base, each of the arms having a distal free end having a depression therein adapted for supporting floss between the ends of the arms in a taut manner.

7. The orthodontia flosser of claim 6, wherein said handle has an elongate depression formed therein at the top end of said handle, said gripping means being disposed on the elongate depression.

8. The orthodontia flosser of claim 7, wherein said gripping means comprises a plurality of finger ridges formed in the depression.

9. The orthodontia flosser of claim 7, wherein said handle includes an enlarged portion at the elongate depression, said handle being substantially rectangular in cross section and gradually flattening towards the bottom end to form a flattened area for placement of the user's palm during use.

10. The orthodontia flosser of claim 6, wherein each of said arms has a recess, a binding post disposed in the recess, and an L-shaped channel extending from the recess toward the distal free end of said arm, the distal end forming spaced prongs defining said depression for supporting the floss, the binding posts on said arms facilitating securing opposite ends of the floss, the remainder of the floss being threaded through the channel in each said arm so that a central portion of the floss is stretched taut between the distal free ends.

11. The orthodontia flosser of claim 10, wherein each said binding post includes an enlarged cap adapted for preventing the floss ends from inadvertently disengaging from said binding posts.
